(19) United States
(12) Patent Application Publication
(10) Pub. No.: US 2015/0154133 A1
(43) Pub. Date: Jun. 4, 2015

(54) APPARATUS FOR PROCESSING PACKETS AND SYSTEM FOR USING THE SAME

(71) Applicant: MEDIATEK INC., Hsinchu City (TW)

(72) Inventor: KUO CHENG LU, HSINCHU CITY (TW)

(21) Appl. No.: 14/617,617

(22) Filed: Feb. 9, 2015

Related U.S. Application Data
(63) Continuation-in-part of application No. 12/540,183, filed on Aug. 12, 2009.

(30) Foreign Application Priority Data
Mar. 23, 2009 (TW) 098109326

(51) Int. Cl. G06F 13/30; G06F 13/42

(52) U.S. Cl. CPC G06F 13/30; G06F 13/4221

(57) ABSTRACT

An apparatus processes a packet and determines that the packet is a processed fast path packet or a slow path packet, wherein the processed fast path packet is forwarded to a fast path forwarding queue directly or is forwarded to a fast path output queue through a packet direct memory access controller. The apparatus not only improves the packet processing performance but also guarantees the quality of service.

### CROSS REFERENCE TO RELATED APPLICATION

The present application is a Continuation-In-Part Application of U.S. patent application Ser. No. 12/540,183 filed on Aug. 12, 2009, which is all incorporated by reference herein.

### BACKGROUND OF THE INVENTION

1. Field of the Invention

The present invention relates to an apparatus for processing packets and a system for using the same, and more particularly to an apparatus for improving the packet processing speed with classified fast path packets and classified slow path packets and a system for using the same.

2. Description of the Related Art

With the popularity of the internet, various applications are increasing rapidly. Numerous organizations devote extensive resources to research seeking improvements in internet data communication quality. When transmitting data in different applications, the allowable packet length varies and systems include a number of processing programs for manipulating packet data, such as examination, decomposition, combination, searching, comparison of content, and data rerouting. Accordingly, with rapid developments of bandwidth requirements in network applications, such as applications in home networks, campus networks, and business networks, as well as increasingly large quantities of packet data transmission, more and more attention is given to improving packet transmission performance and packet processing technology.

Compared to data communication, transmission of voice over IP (VoIP) requires greater quality of service (QoS). The Qos index includes packet latency, packets lost, and packet delay jitter. When a large amount of data is suddenly forwarded in a network, the transmission of the voice packet is affected, and therefore the packet transmission may be postponed or abandoned because the network apparatus cannot handle it in time. When a packet delay occurs during VoIP service, users can distinguish the presence of an echo. An acceptable network transmission environment with good packet data processing performance ensures that the packet delay is less than 150 ms. Acceptable levels of sound delay for users of normal hearing are considered to be about 150 ms to 400 ms, and thus any delay over 400 ms will cause extremely poor sound quality for users.

In order to improve the processing performance, many technologies and methods have been proposed. For example, a specific packet processing engine (PPE) in a system for processing packet data is configured to improve the packet processing speed. FIG. 1 shows a block diagram of a packet processing system. A packet is forwarded to a packet processing engine (PPE) 109 through a media access control (MAC) 111 and a direct memory access (DMA) controller 110. If the packet is processed by the PPE 109 and is classified as a processed fast path packet, then the packet is forwarded directly to a forwarding queue 108. If the packet is processed by the PPE 109 and is classified as a slow path packet, then the packet is forwarded directly to a receiving queue 106. Next, the packet is forwarded to a central processing unit (CPU) core 101 for processing through a packet direct memory access (PDMA) controller 105 and an input queue 102. Subsequently, a processed packet from the CPU core is forwarded to the forwarding queue 108 through an output queue 103, a scheduler 104, and a PDMA controller 107. Finally, the processed packet is forwarded to a wide area network (WAN) port through a DMA controller 112 and a MAC 113. In this system, the PPE 109 can improve the processing speed of the fast path packet and can store the fast path packet to the output queue 108 directly for forwarding. However, due to the limited storage space of the forwarding queue 108, most of the storage space may be occupied by fast path packets and thus the important slow path packets to be forwarded are postponed. Accordingly, current industry research is highly focused on improving both packet processing speeds and quality of service at the same time.

### SUMMARY OF THE INVENTION

An aspect of the present invention is to provide an apparatus for processing packets and a system for using the same. The apparatus processes and determines that a packet is a processed fast path packet or a slow path packet, wherein the processed fast path packet is forwarded to a fast path forwarding queue directly or is forwarded to a fast path output queue through a packet direct memory access controller to guarantee the quality of service.

The first embodiment of the present invention discloses a packet processing apparatus. The packet processing apparatus comprises a PPE, a receiving queue, a first PDMA controller, a second PDMA controller and a forwarding queue. The PPE is configured to process a packet and determine that the packet is a processed fast path packet or a slow path packet, and the receiving queue is configured to store the processed fast path packet. The first PDMA controller is configured to forward the processed fast path packet, which is stored in the receiving queue, to an output queue which is a subsystem of a central processing unit (CPU) system, and the second PDMA controller is configured to receive the processed fast path packet from the output queue. The forwarding queue is connected to the second PDMA controller for storing the processed fast path packet. The fast path packet is a packet which is processed by the PPE without by a CPU core, and the slow path packet is a packet which is processed by both the PPE and the CPU core.

The second embodiment of the present invention discloses a packet processing system. The packet processing system comprises at least one PPE, a receiving queue, an input queue, a first PDMA controller, an output queue, a second PDMA controller, and a forwarding queue. The PPE is configured to process a packet and determine that the packet is a processed fast path packet or a slow path packet, and the receiving queue is configured to store the processed fast path packet. The first PDMA controller is configured to forward the processed fast path packet in the receiving queue, to an output queue which is a subsystem of a central processing unit (CPU) system, the output queue is configured to store the processed fast path packet from the first PDMA controller, and the second PDMA controller is configured to receive the processed fast path packet. The forwarding queue is configured to store the processed fast path packet. The fast path packet is a packet which is processed by the PPE without by a CPU core, and the slow path packet is a packet which is processed by both the PPE and the CPU core.

### BRIEF DESCRIPTION OF THE DRAWINGS

The invention will be described according to the appended drawings in which:

FIG. 1 illustrates a block diagram of a packet processing system;

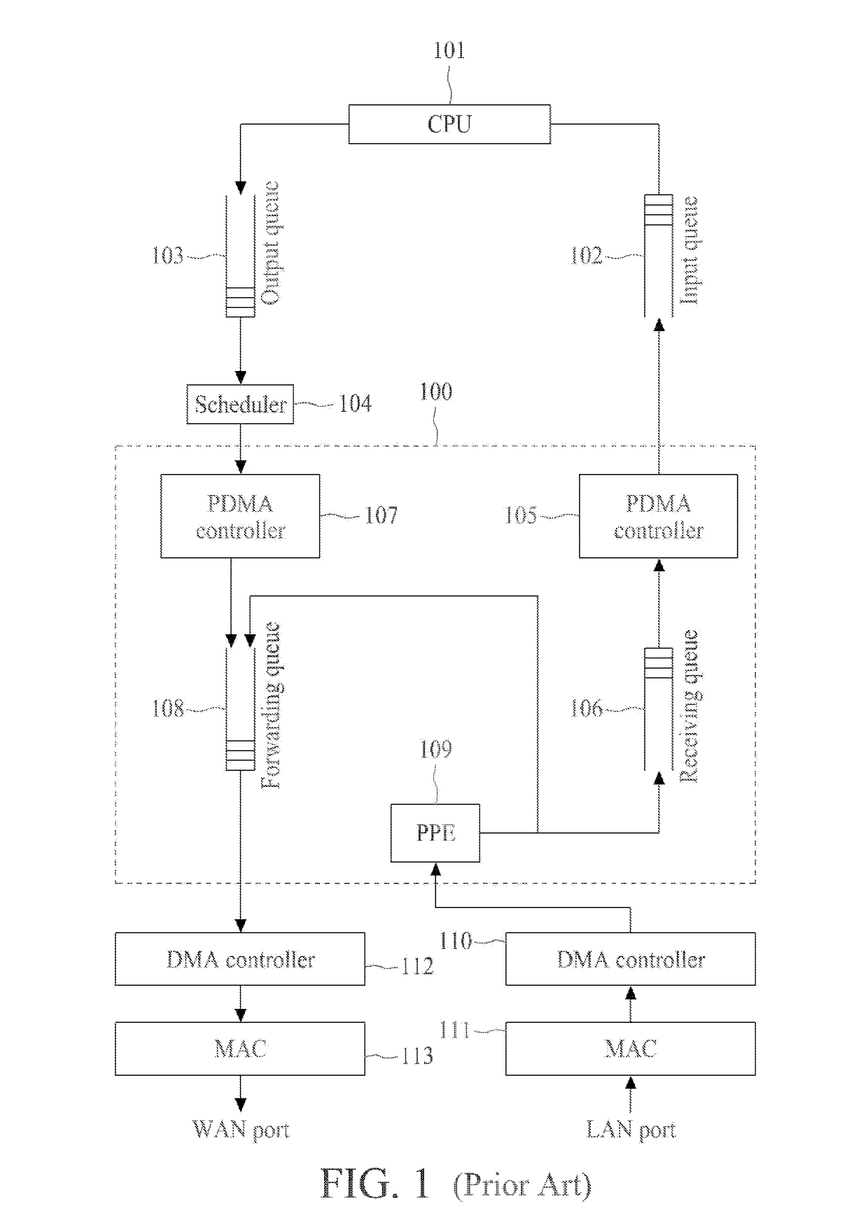

FIG. 2 illustrates a block diagram of a packet processing apparatus according to one embodiment of the present invention;

FIG. 3 illustrates the flow chart of a packet processing method according to one embodiment of the present invention;

FIG. 4 illustrates a block diagram of a packet processing apparatus according to another embodiment of the present invention; and

FIG. 5 illustrates the flow chart of a packet processing method according to another embodiment of the present invention.

### DETAILED DESCRIPTION OF THE INVENTION

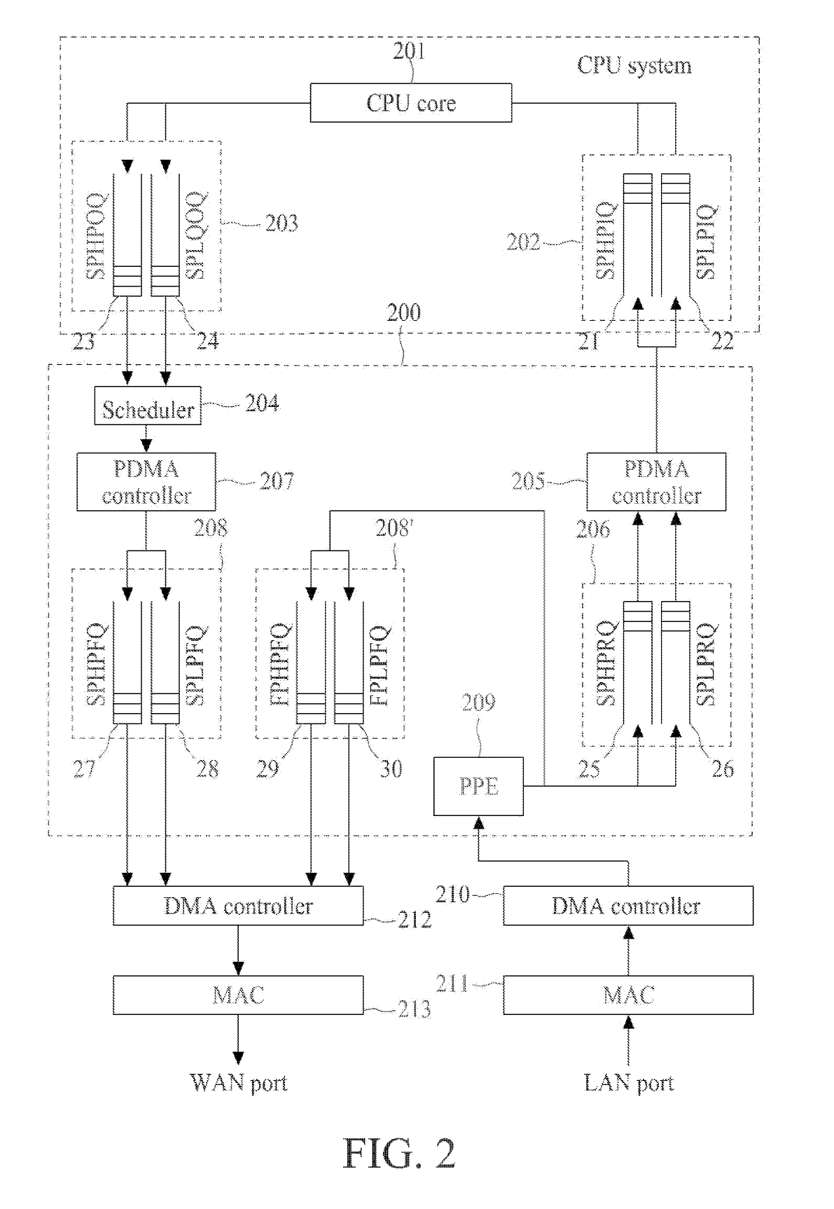

FIG. 2 illustrates a block diagram of a packet processing apparatus according to one embodiment of the present invention. The packet processing apparatus 200 comprises a scheduler 204, a packet direct memory access (PDMA) controller 205, a receiving queue 206, a PDMA controller 207, a slow path forwarding queue (SPFQ) 208, a fast path forwarding queue (FPFQ) 208′, and a packet processing engine (PPE) 209. The receiving queue 206 comprises a slow path high priority receiving queue (SPHPRQ) 25 and a slow path low priority receiving queue (SPLPRQ) 26. The SPFQ 208 comprises a slow path high priority forwarding queue (SPHPFQ) 27 and a slow path low priority forwarding queue (SPLPFQ) 28. The FPFQ 208′ comprises a fast path high priority forwarding queue (FPHPFQ) 29 and a fast path low priority forwarding queue (FPLPFQ) 30. The above-mentioned receiving queue 206, the SPFQ 208, and the FPFQ 208′ are located in a static random access memory (SRAM).

The PPE 209 is configured to process a packet and classify the packet as a processed fast path packet or a slow path packet. The processed fast path packet is a processed fast path high priority packet or a processed fast path low priority packet. The slow path packet is a slow path high priority packet or a slow path low priority packet. The SPHPRQ 25 is utilized to store the slow path high priority packet, and the SPLPRQ 26 is utilized to store the slow path low priority packet. The PDMA controller 205 is utilized to forward a slow path packet, which is stored in the SPLPRQ 26, to an input queue 202. A slow path high priority input queue (SPHPIQ) 21 is utilized to store the slow path high priority packet, and a slow path low priority input queue (SPLPIQ) 22 is utilized to store the slow path low priority packet. The PDMA controller 207 is utilized to receive a processed slow path packet processed by a central processing unit (CPU) core 201, wherein the processed slow path packet is a processed slow path high priority packet or a processed slow path low priority packet. The SPHPFQ 27 is utilized to store the processed slow path high priority packet, and the SPLPFQ 28 is utilized to store the processed slow path low priority packet. The FPHPFQ 29 is utilized to store the processed fast path high priority packet, and the FPLPFQ 30 is utilized to store the processed fast path low priority packet. In order to enable those skilled in the art to practice the present invention, FIG. 2, together with an apparatus for processing packets in accordance with another embodiment, is described as follows.

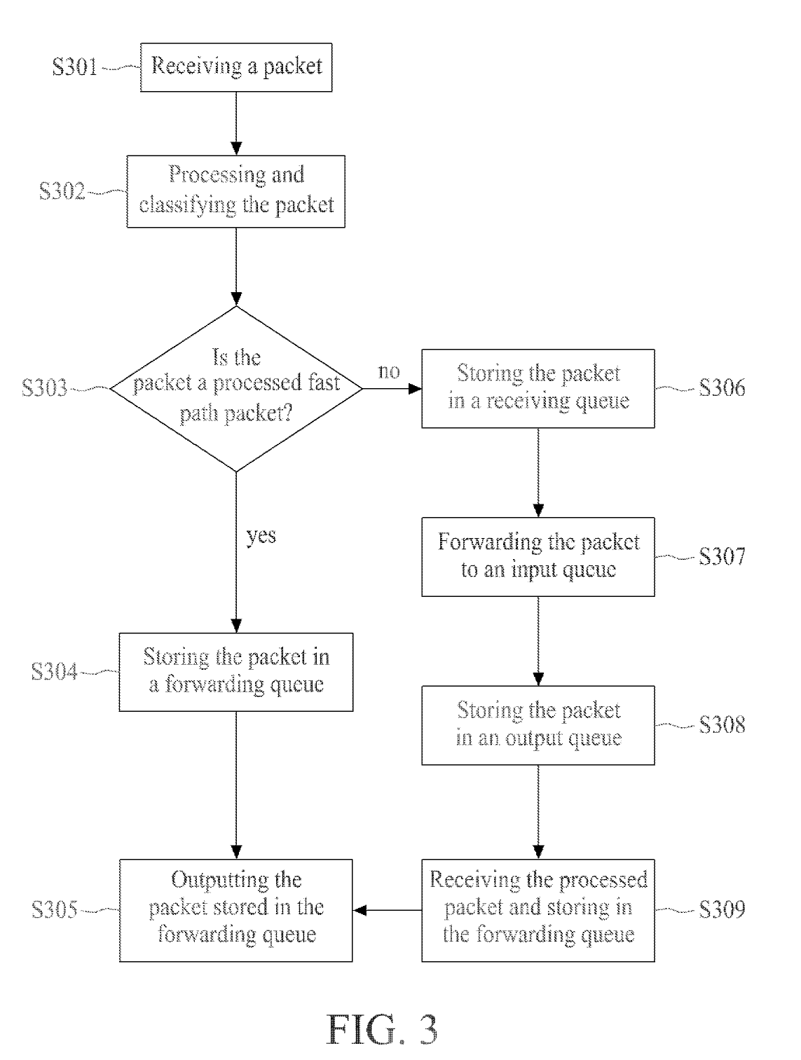

FIG. 3 shows the flow chart of a packet processing method according to another embodiment of the present invention. A packet is inputted through a local area network (LAN) port, and is forwarded to the PPE 209 through a media access control (MAC) 211 and a direct memory access (DMA) controller 210. In step S301, the PPE 209 receives the packet form the DMA controller 210. In step S302, the PPE 209 is utilized to process the packet and classify the packet as a processed fast path packet or a slow path packet, wherein the processed fast path packet is a processed fast path high priority packet or a processed fast path low priority packet, and the slow path packet is a slow path high priority packet or a slow path low priority packet. In step S303, if the packet processed by the PPE 209 was classified as a processed fast path high priority packet or a processed fast path low priority packet, then the processed fast path high priority packet is stored in the FPHPFQ 29 or the processed fast path low priority packet is stored in the FPLPFQ 30 in step S304. In step S303, if the packet processed by the PPE 209 and was classified as a slow path high priority packet or a slow path low priority packet, then the slow path high priority packet is stored to the SPHPRQ 25 or the slow path low priority packet is stored to the SPLPRQ 26 in step S306. In step S307, the slow path high priority packet stored in the SPHPRQ 25 is forwarded to the SPHPIQ 21 through the PDMA controller 205, or the slow path low priority packet stored in the SPLPRQ 26 is forwarded to the SPLPIQ 22. The slow path high priority packet or the slow path low priority packet is processed by the CPU core 201. In step S308, a processed slow path packet is stored in an output queue 203. The output queue 203 comprises a slow path high priority output queue (SPHPOQ) 23 and a slow path low priority output queue (SPLPOQ) 24. The processed slow path packet is a processed slow path high priority packet or a processed slow path low priority packet. The packet stored in the output queue 203 is then forwarded to the PDMA controller 207 through the scheduler 204. In step S309, the processed slow path high priority packet or the processed slow path low priority packet from the PDMA controller 207 is received. If the packet is the processed slow path high priority packet, then the packet is stored in the SPHPFQ 27. If the packet is the processed slow path low priority packet, then the packet is stored in the SPLPFQ 28. In step S305, the packet stored in the SPHPFQ 27, the SPLPFQ 28, the FPHPFQ 29, or the FPLPFQ 30 is outputted to a direct memory access (DMA) controller 212, and is outputted to a wide area network (WAN) port through a media access control 213.

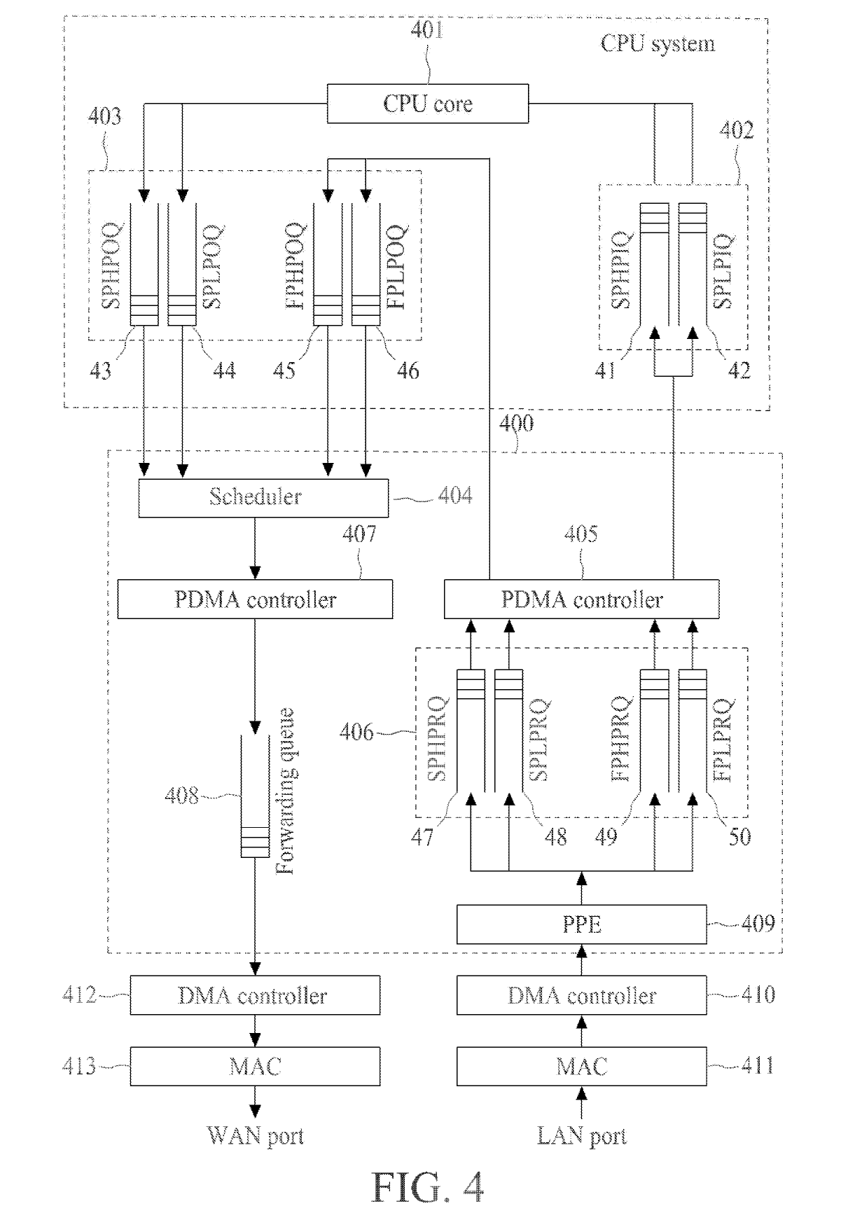

FIG. 4 shows a block diagram of a packet processing apparatus according to another embodiment of the present invention. The packet processing apparatus 400 comprises a scheduler 404, a packet direct memory access (PDMA) controller 405, a receiving queue 406, a packet direct memory access (PDMA) controller 407, a forwarding queue 408, and a packet processing engine (PPE) 409. The receiving queue 406 comprises a slow path high priority receiving queue (SPHPRQ) 47 and a slow path low priority receiving queue (SPLPRQ) 48, a fast path high priority receiving queue (FPHPRQ) 49, and a fast path low priority receiving queue (FPLPRQ) 50. The above-mentioned receiving queue 406 and the forwarding queue 408 are located in a SRAM.

The PPE 409 is utilized to process a packet and classify the packet as a processed fast path packet or a slow path packet. The processed fast path packet is a processed fast path high priority packet or a processed fast path low priority packet. The slow path packet is a slow path high priority packet or a slow path low priority packet. The SPHPRQ 47 is utilized to store the slow path high priority packet, and the SPLPRQ 48 is utilized to store the slow path low priority packet. The FPHPRQ 49 is utilized to store the fast path high priority packet, and the FPLPRQ 50 is utilized to store the fast path low priority packet. The PDMA controller 405 is utilized to forward packets, which are stored in the SPHPRQ 47 or the SPLPRQ 48, to an input queue 402, wherein a slow path high priority input queue (SPHPIQ) 41 is utilized to store the slow path high priority packet, and a slow path low priority input queue (SPLPIQ) 42 is utilized to store the slow path low priority packet. The PDMA controller 405 is also utilized to forward packets, which are stored in the FPHPRQ 49 or in the FPLPRQ 50, to an output queue 403. In the output queue 403, a slow path high priority output queue (SPHPOQ) 43 is utilized to store a processed slow path high priority packet, a slow path low priority output queue (SPLPOQ) 44 is utilized to store a processed slow path low priority packet, a fast path high priority output queue (FPHPOQ) 45 is utilized to store the processed fast path high priority packet, and a fast path low priority output queue (FPLPOQ) 46 is utilized to store the processed fast path low priority packet. The output queue 403 is located in a dynamic random access memory (DRAM), a synchronous DRAM (SDRAM), or a double data rate (DDR) SDRAM. The PDMA controller 407 is utilized to receive the processed fast path high priority packet or the processed fast path low priority packet. The PDMA controller 407 is also utilized to receive the processed slow path high priority packet or the processed slow path low priority packet, both of which are processed by a CPU core 401. The forwarding queue 408 is utilized to store the processed slow path high priority packet, the processed slow path low priority packet, the processed fast path high priority packet, or the processed fast path low priority packet from the PDMA controller 407. In FIG. 4, the output queue 403 is one of subsystems of the CPU system including CPU core 401. For example, the output queue 403 is a buffer which belongs to subsystems of the CPU system. The PDMA controller 405 is utilized to forward the processed fast path high priority packet and the processed fast path low priority packet into the FPHPOQ 45 and FPLPOQ 46 comprised in the output queue 403 respectively, and the processed fast path packet in the FPHPOQ 45 or in the FPLPOQ 46 is forwarded to the PDMA controller 407 through the scheduler 404. That is, although processed fast path packet is forwarded into a subsystem of the CPU system, the fast path packet forwarding procedure is controlled by the PDMA controller 405 and the PDMA controller 407, and the fast path packet forwarding procedure is independent of the controlling of the CPU core 401. In order to enable those skilled in the art to practice the present invention, FIG. 4, together with an apparatus for processing packets in accordance with another embodiment, is described as follows.

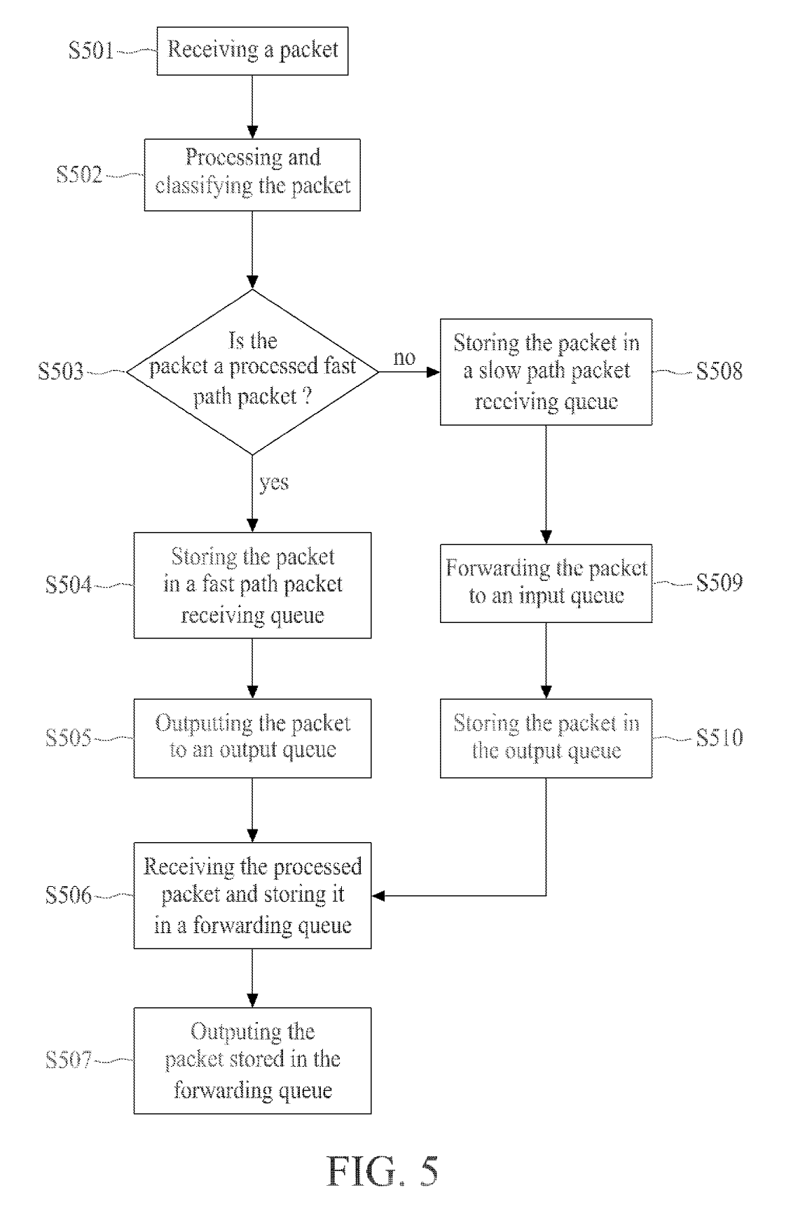

FIG. 5 shows the flow chart of a packet processing method according to another embodiment of the present invention. A packet is inputted through an LNA port, and is forwarded to the PPE 409 through a MAC 411 and a DMA controller 410. In step S501, the PPE 209 receives the packet from the DMA controller 410. In step S502, the PPE 409 is utilized to process the packet and classify the packet as a processed fast path packet or a slow path packet, wherein the processed fast path packet is a processed fast path high priority packet or a processed fast path low priority packet, and the slow path packet is a slow path high priority packet or a slow path low priority packet. In step S503, if the packet processed by the PPE 409 was classified as a processed fast path high priority packet or a processed fast path low priority packet, then the processed fast path high priority packet is stored in the FPHPRQ 49 or the processed fast path low priority packet is stored in the FPLPRQ 50 in step S504, wherein the FPHPOQ 45 and FPLPOQ 46 are located in the output queue 403, which is one of subsystems of the CPU system including the CPU core 401. In step 505, the fast path high priority packet stored in the FPHPRQ 49 is forwarded to the fast path high priority output queue (FPHPOQ) 45 through the PDMA controller 405, or the fast path low priority packet stored in the FPLPRQ 50 is forwarded to the FPLPOQ 46 through the PDMA 405. Next, the packet in the FPHPOQ 45 or in the FPLPOQ 46 is forwarded to the PDMA controller 407 through the scheduler 404. Although fast path packet is forwarded into a subsystem of the CPU system, the fast path packet forwarding procedure is controlled by the PDMA controller 405 and the PDMA controller 407, and the fast path packet forwarding procedure is independent of the controlling of the CPU core 401. In step S503, if the packet processed by the PPE 409 was classified as a slow path high priority packet or a slow path low priority packet, then the slow path high priority packet is stored in the SPHPRQ 47 or the slow path low priority packet is stored in the SPLPRQ 48 in step S508. In step S509, the slow path high priority packet stored in the SPHPRQ 47 is forwarded to the SPHPIQ 41 through the PDMA controller 405, or the slow path low priority packet stored in the SPLPRQ 48 is forwarded to the SPLPIQ 42. The slow path high priority packet or the slow path low priority packet is processed by the CPU core 401. In step S510, a processed slow path packet is stored in the SPHPOQ 43 or in the SPLPOQ 44. Next, the processed slow path packet is forwarded by the scheduler 404 to the PDMA controller 407. The processed slow path packet is a processed slow path high priority packet or a processed slow path low priority packet. In step S506, the processed fast path high priority packet, the processed fast path low priority packet, the processed slow path high priority packet, or the processed slow path low priority packet from the PDMA controller 407 is received and is stored in the forwarding queue 408. In step S507, the processed fast path high priority packet, the processed fast path low priority packet, the processed slow path high priority packet, or the processed slow path low priority packet stored in the forwarding queue 408 is outputted to a DMA controller 412, and is finally outputted to a WAN port through a media access control 413.

The above-described embodiments of the present invention are intended to be illustrative only. Numerous alternative embodiments may be devised by those skilled in the art without departing from the scope of the following claims.

What is claimed is:

1. A packet processing apparatus, comprising:
a packet processing engine (PPE) configured to process a packet and determine the packet is a processed fast path packet or a processed slow path packet;
a receiving queue configured to store the processed fast path packet;
a first packet direct memory access (PDMA) controller configured to forward the processed fast path packet, which is stored in the receiving queue, to an output queue which is a subsystem of a central processing unit (CPU) system;
a second packet direct memory access controller configured to receive the processed fast path packet from the output queue; and
a forwarding queue connected to the second PDMA controller for storing the processed fast path packet,
wherein the fast path packet is a packet which is processed by the PPE without by a CPU core included in the CPU system, and the slow path packet is a packet which is processed by both the PPE and the CPU core.

2. The packet processing apparatus of claim 1, wherein the processed fast path packet is a processed fast path high priority packet or a processed fast path low priority packet, and the receiving queue comprises:
a fast path high priority receiving queue configured to store the processed fast path high priority packet;
a fast path low priority receiving queue configured to store the processed fast path low priority packet.

3. The packet processing apparatus of claim 1, wherein the receiving queue and the forwarding queue are located in a static random access memory.

4. The packet processing apparatus of claim 1, wherein, when the packet is determined to be a processed slow path packet, the receiving queue further configured to store the slow path packet; the first packet direct memory access (PDMA) controller further configured to forward the slow path packet, which is stored in the receiving queue, to an input queue; the second packet direct memory access controller further configured to receive a processed slow path packet; and the forwarding queue further stores the processed slow path packet.

5. The packet processing apparatus of claim 4, wherein the slow path packet is a slow path high priority packet or a slow path low priority packet, and the receiving queue comprise:
a slow path high priority receiving queue configured to store the slow path high priority packet; and
a slow path low priority receiving queue configured to store the slow path low priority packet.

6. A packet processing system, comprising:
at least one packet processing engine (PPE) configured to process a packet and determine the packet is a processed fast path packet or a processed slow path packet;
a receiving queue configured to store the processed fast path packet;
an input queue;
a first packet direct memory access (PDMA) controller configured to forward the processed fast path packet in the receiving queue to an output queue which is a subsystem of a central processing unit (CPU) system;
the output queue configured to store the processed fast path packet from the first PDMA controller;
a second PDMA controller configured to receive the processed fast path packet; and
a forwarding queue configured to store the processed fast path packet,
wherein the fast path packet is a packet which is processed by the PPE without by a CPU core included in the CPU system, and the slow path packet is a packet which is processed by both the PPE and the CPU core.

7. The packet processing system of claim 6, wherein the processed fast path packet is a processed fast path high priority packet or a processed fast path low priority packet, and the receiving queue comprises:
a fast path high priority receiving queue configured to store the processed fast path high priority packet;
a fast path low priority receiving queue configured to store the processed fast path low priority packet.

8. The packet processing system of claim 6, further comprising:
a first media access control (MAC);
a second MAC;
a first direct memory access (DMA) controller configured to forward an input packet, from the first MAC, to the PPE; and
a second direct memory access controller configured to forward an output packet, which is stored in the forwarding queue, to the second MAC.

9. The packet processing system of claim 6, wherein the output queue is located in a dynamic random access memory (DRAM), a synchronous DRAM (SDRAM), or a double data rate SDRAM.

10. The packet processing system of claim 6, wherein the processed fast path packet is a processed fast path high priority packet or a processed fast path low priority packet, and the output queue comprises:
a fast path high priority output queue configured to hold the processed fast path high priority packet forwarded by the first DMA controller;
a fast path low priority output queue configured to hold the processed fast path low priority packet forwarded by the first DMA controller.

11. The packet processing system of claim 6, wherein the receiving queue and the forwarding queue are located in a static random access memory.

12. The packet processing system of claim 6, wherein when the packet is determined to be a processed slow path packet, the receiving queue further configured to store the slow path packet; the first packet direct memory access (PDMA) controller further configured to forward the slow path packet, which is stored in the receiving queue, to the input queue, and the CPU core configured to process the slow path packet stored in the input queue.

13. The packet processing system of claim 12, wherein the output queue further configured to hold the slow path packet processed by the CPU core, the second PDMA controller configured to receive the processed slow path packet, the forwarding queue configured to store the processed slow path packet.

14. The packet processing system of claim 12, wherein the slow path packet is a slow path high priority packet or a slow path low priority packet, and the receiving queue comprises:
a slow path high priority receiving queue configured to store the slow path high priority packet; and
a slow path low priority receiving queue configured to store the slow path low priority packet.

15. The packet processing system of claim 13, wherein the processed slow path packet is a processed slow path high priority packet or a processed slow path low priority packet, and the output queue comprises:
a slow path high priority output queue connected to the CPU core for storing the processed slow path high priority packet; and
a slow path low priority output queue connected to the CPU core for storing the processed slow path low priority packet.
